(19) United States
(12) Patent Application Publication
(10) Pub. No.: US 2026/0001256 A1
(43) Pub. Date: Jan. 1, 2026

(54) METHOD FOR RECYCLING A WASTE BATTERY AND A SYSTEM FOR RECYCLING A WASTE BATTERY

(71) Applicant: ZF Solution Co. Ltd., Gyeonggi-do (KR)

(72) Inventors: JAE YUN ROH, Gyeonggi-do (KR); JEONG WOOK LEE, Gyeonggi-do (KR)

(21) Appl. No.: 18/829,582

(22) Filed: Sep. 10, 2024

(30) Foreign Application Priority Data
Jul. 1, 2024 (KR) 10-2024-0086093

(51) Int. Cl. B29B 17/04; B29B 17/02

(52) U.S. Cl. CPC B29B 17/04; B29B 17/02; B29B 2017/0224; B29B 2017/0436; B29B 2017/0468

(57) ABSTRACT

A method for recycling waste batteries containing electrolytes includes crushing the waste battery in a solution containing an amphiphilic solvent. A system for recycling a waste battery includes a crushing tank in which a waste battery including an electrolyte and a solution including an amphiphilic solvent are contained, a filtration tank for separating the crushed material of the waste battery from the solution, and a separation tank for separating the electrolyte dissolved in the solution from the solution.

### CROSS-REFERENCE TO RELATED APPLICATION AND CLAIM OF PRIORITY

This application claims the benefit under 35 USC § 119 of Korean Patent Application No. 10-2024-0086093, filed on Jul. 1, 2024, in the Korean Intellectual Property Office, the entire disclosure of which is incorporated herein by reference for all purposes.

### BACKGROUND

### 1. Technical Field

The present invention relates to a method for recycling a waste battery and a system for recycling a waste battery.

### 2. Background Art

Recently, battery technology has rapidly advanced, leading to a significant increase in the adoption of electric vehicles and hybrid vehicles.

Particularly, lithium-ion secondary batteries are predominantly used in electric vehicles, and these batteries have a limited lifespan and must be discarded once their lifespan is exhausted.

Waste batteries contain heavy metals and toxic substances such as lithium, cobalt, and nickel. If these materials are released into the environment, they can contaminate soil and water, severely impacting ecosystems and human health. Additionally, lithium, cobalt, and nickel are expensive rare metals, and recycling them helps delay resource depletion and contributes to energy savings required for mining new resources.

Therefore, waste batteries are recycled for resource recovery and environmental protection purposes, involving processes such as battery discharge and separation, decomposition, electrolyte removal, separated material treatment, and waste management.

In this context, electrolytes often contain hazardous substances. Furthermore, electrolytes are highly volatile and, if residual power remains, they can react with the volatilized electrolyte, posing risks of explosions or fires.

To address these issues, conventional methods have absorbed electrolytes using absorbents like activated carbon or processed them in secure containers.

However, absorbents such as activated carbon have low absorption efficiency, requiring a large quantity of activated carbon to safely remove the electrolyte. Similarly, processing in containers also suffers from very low efficiency, indicating a continued need for technological development.

### SUMMARY

The present invention aims to provide a method for safely and efficiently recycling waste batteries containing electrolytes.

The present invention aims to provide a system for safely and efficiently recycling waste batteries containing electrolytes.

1. A method for recycling a waste battery containing an electrolyte, comprising a step of crushing the waste battery under a solution containing an amphiphilic solvent.

2. The method for recycling a waste battery according to 1 above, wherein the amphiphilic solvent is ethyl-3-hydroxypropanoate.

3. The method for recycling a waste battery according to 2 above, wherein the amphiphilic solvent further comprises glycerol carbonate or ethylene carbonate.

4. The method for recycling a waste battery according to 1 above, further comprising a step of separating the crushed material of the waste battery from the solution.

5. The method for recycling a waste battery according to 4 above, further comprising a step of separating the electrolyte dissolved in the solution from the solution.

6. The method for recycling a waste battery according to 5 above, further comprising a step of reusing the solution from which the electrolyte has been separated in the crushing step.

7. A system for recycling a waste battery, comprising: a crushing tank in which a waste battery containing an electrolyte and a solution containing an amphiphilic solvent are contained; a filtration tank for separating the crushed material of the waste battery from the solution; and a separation tank for separating the electrolyte dissolved in the solution from the solution.

The present invention can achieve the effects of reducing fire risk and increasing electrolyte removal efficiency by crushing waste batteries in a solution containing an amphiphilic solvent.

### BRIEF DESCRIPTION OF THE DRAWINGS

FIGS. 1A to 1D are schematic diagrams of the crushing step.

FIG. 2 is a schematic diagram of the step of separating the crushed material of the waste battery from the solution containing an amphiphilic solvent.

FIG. 3 is a schematic diagram of the step of separating and reusing the electrolyte.

### DETAILED DESCRIPTION

Hereinafter, the present invention will be described in detail.

The present invention relates to a method for recycling waste batteries containing electrolytes, comprising a step of crushing the waste battery in a solution containing an amphiphilic solvent.

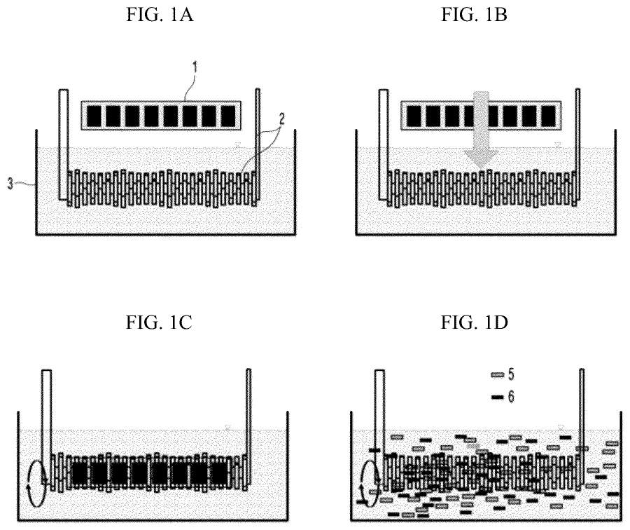

FIGS. 1A to 1D are schematic diagrams of the crushing step.

Referring to FIGS. 1A to 1D, the crushing step involves introducing the waste battery containing the electrolyte (1) into a crushing tank (3) that contains a crushing device (4) and a solution (4) containing an amphiphilic solvent, and separating it into the electrolyte (5) and crushed waste battery material (6).

Waste batteries containing electrolytes can include any battery that uses an electrolyte without limitation. For example, it can be lithium-ion batteries, lead-acid batteries, nickel-cadmium batteries, nickel-metal hydride batteries, and so on.

Lithium-ion batteries can be used in portable electronic devices such as smartphones, laptops, and drones, as well as in electric vehicle batteries (EV) and energy storage systems (ESS).

Lead-acid batteries can be used in applications such as car starter batteries, uninterruptible power supplies (UPS), electric wheelchairs and carts, and renewable energy storage systems.

Electrolytes can include, for example, carbonate ester organic solvents, carbonate organic solvents, and ether organic solvents.

The electrolytes can include, for example, diethyl carbonate (DEC), propylene carbonate (PC), ethyl methyl carbonate (EMC), and dimethyl carbonate (DMC).

If necessary, the method can further include a step of discharging the waste battery containing the electrolyte before crushing.

Discharging can be done by connecting the waste battery containing the electrolyte to a resistor or immersing it in brine.

In conventional methods of recycling waste batteries, the battery is discharged and dismantled into components such as the case, electrodes, and electrolyte.

During the process of separating components, the electrolyte can leak and volatilize, potentially reacting with residual current and causing an explosion.

Explosions can be accompanied by or lead to fires.

Thus, the process of separating the waste battery into components poses risks of explosion, fire, and exposure to harmful gases, necessitating the use of protective equipment and performing the work in a sealed environment.

Additionally, separated electrolytes, being hazardous substances, must be safely handled using absorbents or appropriate containers, involving additional processing steps.

In some cases, waste batteries are crushed in closed systems to prevent the electrolyte and gases from leaking into the environment. However, such closed environments can actually create more dangerous conditions in the event of a fire or explosion.

In contrast, the present invention allows for simultaneous separation of the components and absorption of the electrolyte.

By performing electrolyte absorption under a solution, the invention fundamentally resolves the issue of electrolyte volatilization that can lead to explosions and fires.

Amphiphilic solvents have a high solubility for waste battery electrolytes, meaning they can dissolve the electrolyte completely without phase separation.

Amphiphilic solvents can also be non-volatile.

Most electrolytes are volatile substances. If they leak during the separation or absorption process, they can evaporate into the atmosphere, posing explosion and fire risks.

When dissolved in an amphiphilic solvent, the vapor pressure of the electrolyte is significantly reduced, preventing it from evaporating into the atmosphere. This greatly reduces the risk of explosions and fires during the recycling process.

Amphiphilic solvents can dissolve both hydrophobic and hydrophilic substances due to their dual nature.

The hydrophobic part of the amphiphilic solvent can safely dissolve and separate the electrolyte.

If necessary, the solution can further include water.

The hydrophilic part of the amphiphilic solvent reduces the interfacial tension between water and the electrolyte, allowing complete dissolution without phase separation.

For example, water can be mixed in emergencies or during the final washing step.

In case of fire, water can easily extinguish it.

Additionally, any residual electrolyte and amphiphilic solvent in the finally recovered solids can be completely removed with water.

The amount of water is not specifically limited and can be applied sufficiently as needed.

Amphiphilic solvents improve the chemical stability of the crushing step because they do not induce additional chemical reactions with the waste battery containing the electrolyte.

Amphiphilic solvents can be green chemical products produced by biological methods. Green chemical products do not affect the surrounding environment after use and decompose quickly over time.

Amphiphilic solvents can have high flash points and boiling points and can dissolve both water and electrolytes.

The flash point of the amphiphilic solvent can be, for example, 100° C. to 200° C., 110° C. to 190° C., and 110° C. to 150° C.

The boiling point of the amphiphilic solvent can be, for example, 100° C. to 400° C., 150° C. to 400° C., and 180° C. to 350° C.

The amphiphilic solvent can be ethyl-3-hydroxypropanoate.

Ethyl-3-hydroxypropanoate (C₅H₁₀O₃, ethyl-3-hydroxypropanoate, EHP) can be represented by the following chemical formula 1.

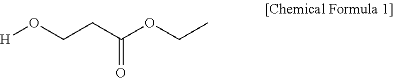

The hydroxyl group of ethyl-3-hydroxypropanoate binds with water, reducing the interfacial tension between water and the electrolyte.

The ethyl group of ethyl-3-hydroxypropanoate binds with the electrolyte, separating it from the waste battery and preventing it from volatilizing into the air.

The amphiphilic solvent may further include glycerol carbonate or ethylene carbonate.

Glycerol carbonate (C₄H₆O₄, glycerol carbonate, GC) can be represented by the following chemical formula 2.

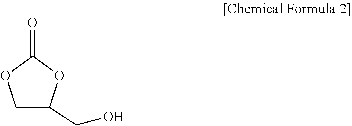

The hydroxyl group of glycerol carbonate binds with water, reducing the interfacial tension between water and the electrolyte.

Ethylene carbonate (C₃H₄O₃, ethylene carbonate, EC) can be represented by the following chemical formula 3.

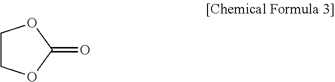

Ethylene carbonate is a water-soluble substance that dissolves the electrolyte well and has a high flash point (160° C.).

When an amphiphilic solvent includes multiple solvents, the mixing ratio can be adjusted according to the type and content of the electrolyte in the waste battery.

The amphiphilic solvent can be a mixture of ethyl-3-hydroxypropanoate, glycerol carbonate, or ethylene carbonate, each in a ratio of 0 to 80 vol %.

The crusher used in the crushing step can be appropriately selected and applied based on the size, shape, and material characteristics of the waste battery containing the electrolyte, using physical crushing methods commonly employed in the field. For example, a jaw crusher, hammer mill, roll crusher, high-speed shredder, double shaft shredder, cryogenic mill, ball mill, or ultrasonic mill can be used alone or in combination.

The crushing step can be subdivided into primary crushing, secondary crushing, tertiary crushing, and fine grinding as needed.

It is preferable that primary, secondary, tertiary, and fine crushing are all performed under a solution containing an amphiphilic solvent.

Primary crushing can be the first step to disassemble or dismantle the waste battery pack into large pieces and separate the internal components.

Primary crushing can reduce the waste battery pack to an average diameter of 20 to 50 mm.

Primary crushing can be performed using a jaw crusher or double shaft shredder.

Secondary crushing can involve further crushing the pieces obtained from primary crushing into smaller sizes to facilitate material separation.

Secondary crushing can reduce the waste battery to an average diameter of 10 to 20 mm.

Secondary crushing can be performed using a hammer mill or roll crusher.

Tertiary crushing can involve further finely crushing the pieces obtained from secondary crushing to efficiently process them in the recycling process.

Tertiary crushing can reduce the waste battery to an average diameter of 1 to 10 mm.

Tertiary crushing can be performed using a high-speed shredder or cryogenic mill.

Fine grinding can be selectively performed to precisely recover specific materials or process them into powder form.

Fine grinding can reduce the waste battery to an average diameter of 10 μm to 1 mm.

Fine grinding can be performed using a ball mill or ultrasonic mill.

The method for recycling waste batteries of the present invention may further include a step of separating the crushed waste battery material from the solution containing the amphiphilic solvent.

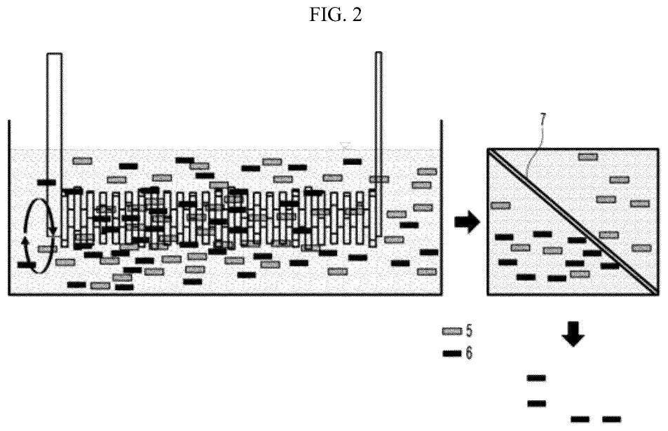

FIG. 2 is a schematic diagram of the step of separating the crushed waste battery material from the solution containing the amphiphilic solvent.

Referring to FIG. 2, the step of separating the crushed waste battery material from the solution containing the amphiphilic solvent can involve separating the crushed waste battery material (6), the electrolyte (5), and the solution containing the amphiphilic solvent using a filter (7).

The solution may contain dissolved electrolytes.

The separation can be done by filtration or sedimentation, for example.

Filtration involves filtering the crushed material to separate it from the solution and can be performed using screens, filters, or filter presses.

Sedimentation involves letting the solution stand to settle the crushed material and then separating the supernatant solution.

The method for recycling waste batteries of the present invention may further include a step of separating the electrolyte dissolved in the solution obtained from the crushed waste battery material.

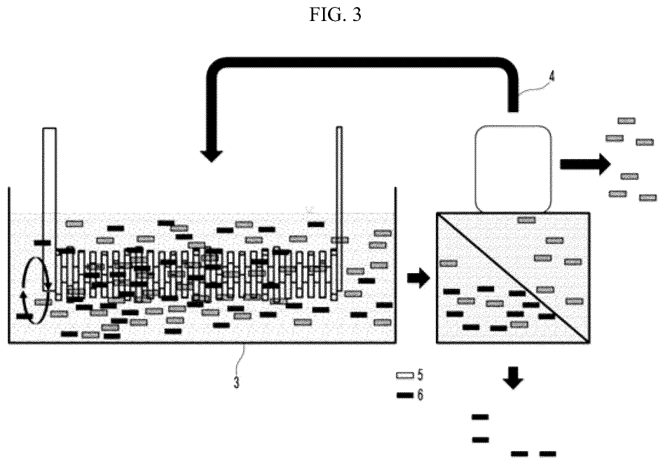

FIG. 3 is a schematic diagram of the step of separating and reusing the electrolyte.

Referring to FIG. 3, the step of separating the electrolyte involves separating the electrolyte (5) dissolved in the solution obtained from the crushed waste battery material (6).

Any method for separating liquids commonly used in the field can be applied without limitation. For example, distillation, extraction, chromatography, recrystallization, and fractional sedimentation can be used alone or in combination.

The method for recycling waste batteries of the present invention may further include a step of reusing the solution from which the electrolyte has been separated in the crushing step.

Referring to FIG. 3, the reuse step involves introducing the solution (4) from which the electrolyte (5) has been separated back into the crushing tank (3).

The solution introduced into the crushing step may include the amphiphilic solvent and water alone or in combination, with the concentration of each adjusted as needed.

The method for recycling waste batteries of the present invention may further include a step of recovering black powder or valuable metals from the separated crushed waste battery material.

The recovery of black powder or valuable metals can be performed through physical, chemical, or electrochemical treatments.

Through physical treatment, the crushed waste battery material can be separated into metals and non-metals.

Physical treatments can include, for example, magnetic separation, gravity separation, and centrifugal separation.

Through chemical treatment, metal ions can be extracted from the crushed waste battery material.

Chemical treatments can include, for example, acid leaching and alkaline leaching.

Through electrochemical treatment, metals can be recovered.

Electrochemical treatment can be electrowinning.

The recovered metals can be refined to increase their purity.

The present invention relates to a system for recycling a waste battery, comprising a crushing tank in which a waste battery containing an electrolyte and a solution containing an amphiphilic solvent are contained, a filtration tank for separating the crushed material of the waste battery from the solution, and a separation tank for separating the electrolyte dissolved in the solution from the solution.

The crushing tank can contain a solution with an amphiphilic solvent. Waste batteries containing electrolytes are crushed in a solution containing an amphiphilic solvent and sent to the filtration tank.

The solution containing the amphiphilic solvent dissolves the electrolyte in the crushed waste battery.

The crushing tank may further include a crusher.

The crusher can be selected and applied based on the size, shape, and material characteristics of the waste battery containing the electrolyte, using physical crushing methods commonly employed in the field. For example, a jaw crusher, hammer mill, roll crusher, high-speed shredder, double shaft shredder, cryogenic mill, ball mill, or ultrasonic mill can be used alone or in combination.

The filtration tank separates the crushed waste battery material and the solution from the crushing tank.

The filtration tank can include, for example, screens, filters, and filter presses.

The solution separated by the filtration tank moves to the separation tank.

The separation tank separates the dissolved electrolyte from the solution separated by the filtration tank.

The separation tank can separate the electrolyte using, for example, distillation, extraction, chromatography, recrystallization, and fractional sedimentation.

The separation tank can separate the amphiphilic solvent and water from the solution from which the electrolyte has been separated, either alone or in combination.

The separation tank may further include a recovery unit connected to the crushing tank.

The separated amphiphilic solvent can be introduced into the crushing tank and reused through the recovery unit.

### Example 1

A waste lithium-ion battery was soaked in a 5% saline solution for 24 hours to completely discharge it, then prepared by wiping off the saline solution. The discharged waste lithium-ion battery was then immersed in 3 L of ethyl-3-hydroxypropanoate (in a 5 L volume) and crushed using a roll crusher attached to the crushing tank until the waste battery had an average diameter of 10 mm, and the solid crushed material and the solution were separated using a filter press.

### Example 2

The waste lithium-ion battery was treated in the same manner as in Example 1, except that glycerol carbonate was used instead of ethyl-3-hydroxypropanoate.

### Example 3

The waste lithium-ion battery was treated in the same manner as in Example 1, except that a mixture of 1.5 L of ethyl-3-hydroxypropanoate and 1.5 L of glycerol carbonate was used instead of 3 L of ethyl-3-hydroxypropanoate.

### Example 4

The waste lithium-ion battery was treated in the same manner as in Example 1, except that a mixture of 2 L of ethyl-3-hydroxypropanoate and 1 L of ethylene carbonate was used instead of 3 L of ethyl-3-hydroxypropanoate.

### Comparative Example 1

A waste lithium-ion battery was soaked in a 5% saline solution for 24 hours to completely discharge it, then prepared by wiping off the saline solution. The waste battery was then crushed using a roll crusher until it had an average diameter of 10 mm.

### Comparative Example 2

A waste lithium-ion battery was soaked in a 5% saline solution for 24 hours to completely discharge it, then prepared by wiping off the saline solution. The discharged waste lithium-ion battery was then immersed in 3 L of water (in a 5 L volume) and crushed using a roll crusher attached to the crushing tank until the waste battery had an average diameter of 10 mm. The solid crushed material and the solution were separated using a filter press.

### Evaluation Example 1

The internal vapor of the crushing tank from Examples 1 to 4 and Comparative Examples 1 and 2 was collected, and it was measured whether the vapor contained any electrolyte. The evaporation concentration measurements of the electrolyte substances were compared to evaluate the reduction in risk.

TABLE 1

Category

| | Shredding fluid | VOC concentration in |
|---|---|---|
| | conditions | the shredder (ppm) |
| Comparative | None | 3,851 |
| Example 1 | | |
| Comparative | Water | 1,145 |
| Example 2 | | |
| Example 1 | EHP (100%) | 281 |
| Example 2 | GC (100%) | 368 |
| Example 3 | EHP + GC (1:1) | 325 |
| Example 4 | EHP + EC (2:1) | 126 |

As shown in Table 1, a significantly high concentration of volatile organic compounds (VOC) was measured in Comparative Example 1, originating from the electrolyte leaked from the crushed waste battery material. Although no fire occurred during the experiment using small batteries, it could be quite dangerous with larger batteries such as those used in electric vehicles. In the case of Comparative Example 2, the concentration was about one-third of that with no additive, but it was still high, and a large amount of water would be required to maintain a low concentration, potentially causing wastewater issues. In contrast, in Examples 1 to 4, there were slight differences in VOCs, but the gaseous concentration measured was significantly lower, at one-tenth to one-twentieth of that in Comparative Examples 1 and 2, indicating that safe shredding with a very low risk of fire is possible.

### Evaluation Example 2

To indirectly evaluate the residual amount of volatile electrolyte in the separated solid crushed material, 30 g of each separated solid crushed material from Examples 1 to 4 and Comparative Examples 1 and 2 was placed in a 1 L Tedlar bag for air sampling, which was then sealed. After leaving the bag at 30° C. for 1 hour to allow natural volatilization, the air inside the bag was sampled, and the concentration of total volatile organic compounds (VOCs) was measured. The concentration measurement was performed using a photoionization detector (PID).

The presence of electrolytes in the separated solid crushed materials from Examples 1 to 4 and Comparative Examples 1 and 2 was measured and shown in Table 2. As can be seen from the evaluation results, the VOC concentration measured from the crushed material volatilized in Examples 1 to 4, where amphiphilic solvents were used, was significantly lower than that in Comparative Examples 1 and 2. Therefore, the washing of residual electrolytes by the solvents appears to be very effective.

Moreover, when ‘secondary washing with water’ was added after crushing in Example 4, the residual electrolyte concentration (indirect gaseous concentration) was observed to be very low. This indicates that the method for shredding waste batteries according to the present invention can produce high-quality black powder with very little residual electrolyte.

TABLE 2

| | Shredding Fluid | VOC concentration |
|---|---|---|
| Condition Number | Conditions | (ppm) |
| Comparative | None | 967 |
| Example 1 | | |
| Comparative | Water | 478 |
| Example 2 | | |
| Example 1 | EHP (100%) | 86 |
| Example 2 | GC (100%) | 102 |
| Example 3 | EHP + GC (1:1) | 91 |
| Example 4 | EHP + EC (2:1) | 55 |
| | Example 4 washed | 6 |
| | with water | |

What is claimed is:

1. A method for recycling a waste battery containing an electrolyte, the method comprising crushing the waste battery under a solution comprising an amphiphilic solvent.

2. The method according to claim 1, wherein the amphiphilic solvent is ethyl-3-hydroxypropanoate.

3. The method according to claim 2, wherein the amphiphilic solvent further comprises glycerol carbonate or ethylene carbonate.

4. The method according to claim 1, further comprising a step of separating the crushed material of the waste battery from the solution.

5. The method according to claim 4, further comprising a step of separating the electrolyte dissolved in the solution from the solution.

6. The method according to claim 5, further comprising a step of reusing the solution from which the electrolyte has been separated in the crushing step.

7. A system for recycling a waste battery, comprising:
a crushing tank in which a waste battery comprising an electrolyte and a solution comprising an amphiphilic solvent are contained;
a filtration tank for separating the crushed material of the waste battery from the solution; and
a separation tank for separating the electrolyte dissolved in the solution from the solution.
